(19) United States
(12) Patent Application Publication
(10) Pub. No.: US 2008/0010125 A1
(43) Pub. Date: Jan. 10, 2008

(54) System and Method For Enabling Bi-Directional Communication Between Providers And Consumers of Information In Multi-Level Markets Using A Computer Network

(76) Inventor: Rocky Wright, Corona, CA (US)

Correspondence Address: Gregory Richardson, Suite 210, 3890 11th Street, Riverside, CA, 92501, US

(21) Appl. No.: 11/426,920

(22) Filed: Jun. 27, 2006

(51) Int. Cl. G06Q 30/00

(52) U.S. Cl. 705/14

(57) ABSTRACT

A system and method for enabling continuous bidirectional communication between providers and consumers of information through a computer and telephone network to exchange product and preference information. The system and method of the invention provides a database having accounts for providers and consumers. Each account contains contact, warranty, product, system usage, and billing information for providers, and contact, demographic, product preference, contact permissions, and usage history information for consumers. The invention provides an area for consolidation of all provider access points in a taskbar on the user's computer or communication device. The invention creates an ad reviewing cart that allows users to select providers and content to be received. An information warehouse manager is employed to receive data from providers and users. A commission accounting module calculates commissions.

### PRIOR ART

This application for a utility patent claims priority from the provisional Patent Application, 60/694,126 filed on Jun. 27, 2005.

### U.S. Patent Documents

| | | | |
|---|---|---|---|
| 5,347,632 | | Sep. 13, 1994 | Prodigy |
| 5,761,648 | | Jan. 02, 1998 | Interactive Coupon Network |
| 5,948,061 | | Sep. 07, 1999 | Double Click, Inc. |
| 6,009,413 | | Dec. 28, 1999 | America Online, Inc. |
| 6,026,368 | | Feb. 15, 2000 | 24/7 Media, Inc. |
| 6,029,141 | | Feb. 22, 2000 | Amazon.com |
| 6,269,361 | B1 | Jul. 31, 2001 | Goto.com |
| 6,332,129 | B1 | Dec. 18, 2001 | priceline.com |
| 6,381,594 | B1 | Apr. 30, 2002 | Yahoo! Inc. |
| 6,525,747 | B1 | Feb. 25, 2003 | Amazon.com |
| 0078928 | A1 | Apr. 24, 2003 | Dorosario et al |
| 0216335 | A1 | Sep. 29, 2005 | Fikes et al |
| 0222901 | A1 | Oct. 06, 2005 | Agarwal et al |
| 0222989 | A1 | Oct. 06, 2005 | Haveliwala et al |
| 0004627 | A1 | Jan. 06, 2006 | Baluja et al |

### FIELD OF THE INVENTION

This invention relates to both conventional business and advertising as well as electronic advertising and e-commerce. The system allows providers of content to target willing consumers and willing consumers to select preferred providers while enabling communications between the two groups. Specifically, this invention relates to intelligent information processing methods for creating content and sending to targeted groups and individuals, while providing relationship building tools for the providers and users, all through a bi-directional communications platform.

### BACKGROUND OF THE INVENTION

Many examples of two-sided markets exist: Videogame platforms, such as Atari, Nintendo, Sega, Sony Play Station, and Microsoft X-Box need to attract gamers or users in order to recruit game developers to design, port or produce games for their platform while also needing games in order to induce gamers to buy and use their product. Similarly, software producers need both users and application developers. Portals, web-sites, T.V. and radio networks, newspapers and other print media compete for advertisers as well as “eyeballs”.

Advertiser-consumer markets are another example of two-sided markets because both sides have information, products, services, content or data that are valuable to the other side.0 However, the expense and difficulty of communications between providers and users prevents establishing a fully functional market between the two.

In the advertising-consumer markets, problems persist in enabling communications between the advertiser and the consumer. The costs in terms of time and labor to collect data on individual consumers are high. Typically there is no reward for collecting or making the information available because no one is willing to pay for it or once it becomes available the provider loses any competitive advantage they had in collecting the information. On the other hand, consumers continue to face a daunting array of Web sites, unsolicited e-mails, spam, and other information. Finally, consumers and to some extent businesses are concerned about privacy and overload since junk e-mail and identity theft are major threats.

Ultimately, however, there remain substantial benefits for both advertisers and consumers to participate in building long-term relationships by exchanging information through a platform that they both control. The goal of advertisers is to target marketing communications to individual consumers based on demographic and behavior data while the goal of consumers is to receive as much information as they want to make informed choices without being inundated or losing their privacy. The goal of both parties is to avoid high costs and minimize time and expense of participating.

Within the advertising industry a long-standing goal is to provide individualized ads that are targeted to selected consumers in a non-offensive manner. Traditional radio, T.V., newspaper, and other print media advertising reach a large audience. While the target is large, the efficiency of these mass media is low. Moreover, there is no way for the provider to pick out of the mass audience those individual consumers that are most likely to respond to the message.

In the mass media advertising campaigns, the individual consumer has little or no influence on the content or targets of the advertising campaigns. Even if consumer data is collected at the point of sale or the consumer fills out a questionnaire, there is little opportunity for the advertiser or provider to modify their campaign in time to respond effectively to input or feedback from the user. Thus, significant opportunities for interaction between advertisers and consumers never materialize. There is a need in the industry for a bi-directional communications medium for advertisers to send content to users, for users to consume the message and respond to the providers, and then for providers to send further targeted marketing communications.

The traditional advertising models have been grafted onto the on-line world. However, mass e-communications of e-mail and indiscriminate use of pop-up ads turn off consumers just as effectively as traditional mass mailings. Nonetheless, the Internet still presents great opportunities for matching buyers with sellers and providers of information with consumers.

From the very beginnings of the Internet, using dial-up access has made the lives of consumers better by creating an online experiences that informs and delights. With the increasing popularity of the Internet and the World Wide Web, it has become common to buy, sell, and advertise on the Internet. To-date, the conventional advertising and retailing models have been adapted to the Internet with some success in terms of ease of use and sales. However, one remaining problem for providers is that there is no easy means for sellers and buyers to establish a relationship before a sale and no mechanism for building the relationship post-sale based on the individual preferences of the consumer.

AOL created unique channel navigation and improved Internet search features, including audio/video and local search while providing original content. AOL bridged the gap between the providers and consumers by creating on-line communities. Although a pioneer in making online communications easy and fun, including on-line advertising, the AOL model of using banner ads and click-ons ads is limited. A significant problem remained that there was no way to establish continuous relationships between the advertisers and consumers because once the consumer clicked-on a banner advertisement, there was little to hold him to the site of the advertiser.

Even as e-commerce grew tremendously, buyers and sellers were still separated, until eBay developed an online person-to-person trading community. Buyers and sellers are brought together through online auctions in which sellers list items for sale and buyers bid. eBay users browse through listed items, and the items are arranged by topics, where each type of auction has its own category. eBay's on-line format provides continuous dialogue between buyers and sellers and facilitates easy offering and bidding, both globally and locally. Still, there is little reason or capacity for either party to establish a long-term relationship beyond that of buyer and seller or extending beyond the trading arena.

In an attempt to allow relationship building, eBay and other companies now provide entire platforms for operating businesses with feedback forums. However, eBay's method for obtaining information from consumers is limited to registered sellers and buyers. The focus remains with on-line trading and the exchange of goods and services, with no mechanism to facilitate the exchange of information from sellers and preferences of buyers that would lead to longer-term relationships. Thus, there remains a need in the industry for a means for exchanging information between providers and users well before a transaction takes place, and even between parties which may never transact business in the traditional sense.

As the number and type of e-commerce transactions continued to grow, there were only limited means for using the information from one transaction to generate another, until Amazon started tracking user buying patterns in order to cross-sell users a wide range of items suited to their personal tastes. Amazon's method for obtaining information from consumers is limited to cross-selling where sales and purchases have already taken place. The merchant's ability to glean information about a potential customer is limited still to the data collected by the website. Thus, there is a need in the industry for enabling communication between sellers and buyers along the entire continuum of interactions, from actual sales and purchase transactions to expressions of interest in products and brands by consumers to focus group marketing by sellers.

Finding information and websites on the Internet has always been easy, but presenting the results in a useful format has always been difficult. In the absence of the bid-for-placement mechanism, ad pricing is inefficient. Hence, on-line advertising had limited potential, until Overture pioneered the bid-for-placement mechanism that allowed advertisers to change the rank of their ads. However, the bid-for-placement mechanism was limited to subscribers, and there was no means for storing information pertaining to the bid and the targeted consumer over a long period of time. The bid-for-placement was an innovation because it enabled the pricing of ads based on perceived value, but its scope is limited to on-line advertisers and buyers who participated in Internet search. Thus, there remains a need in the industry for a means for providers to place information where those who want it may receive it, while allowing either side to pay for the costs of providing or reviewing information through making payments, commissions or participating in the program.

Google pioneered indexed-based searches and subsequently linking search results to ads. Google's profitability comes from its search technology combined with text ads and an ad placement mechanism. Advertisers bid for placement of their ads (bid-for-placement mechanism). Goto.com created a system for influencing a position of a search in a result list. Bid-for-placement frees up extensive resources that would otherwise be required to set ad prices, and it allows advertisers to charge ad sponsors in proportion to the value added by the advertiser. However, the full value added of advertising that reflects the input of both advertisers and users remains to be realized because the consumer plays no part directly. In its various forms, bid-for-placement still does not enable continuous communication between the provider and user, or the advertiser and consumer or maximizing of value added in the advertiser-consumer market.

Google pioneered the link between index-based searches and advertising. Google focuses on delivering contextual based advertising through the AdWords program. Google reaches people when they are actively looking for information about products and services online by offering a link to or sending users to targeted web sites and pages. AdWords enable providers to control costs by charging only when people click on their ads. Google AdSense™ automatically delivers text and image ads that are precisely targeted to an advertiser's site and content. However, there is a need to augment this technology so that the relationship between provider and consumer or seller and buyer extends beyond Internet advertisements.

Amazon pioneered an Internet-based customer referral system. Individuals and businesses (“associates”) market and sell products in return for a commission.

In today's environment, with searches and ads integrated with user preferences and past behavior and with so many options open to the consumer and so many on-line transactions, it has become difficult for consumers to keep track of all their past transactions and current points of interest in products and providers. Thus there is a need in the industry for a consolidated single point of access to all providers as well as a common communication platform between providers and users.

With so many providers making so many types of information available, making all content available through a single platform has become impossible. Thus there is a need in the industry for a single platform and format for creating content, soliciting and storing data from providers and users, and enabling users to access providers through a single access point.

Although information on consumers from prior searches and sales are now routinely gleaned and amalgamated, there remains a need in the industry to extend the scope of such data mining beyond sales data to all aspects of pre- and post-sales, including exchanging information about brands and products along with consumer data and preferences. There is also a need in the industry for providers and consumers to exchange information, and for each party to analyze and respond accordingly.

Push. The transfer of information between providers and consumers has become both widespread and pervasive. Today advertisers and brand managers have a plethora of content distribution channels, but also rising costs and inefficiencies. Consumers increasingly are able to dynamically communicate with brand managers through games and promotions, but have little influence on the information they receive.

Transferring information over computer networks is an increasingly important means for institutions and individuals to do business and become informed. Such information transfers occur both publicly on the Internet, which is a worldwide interconnection of computer and computer networks using a common protocol, and privately through virtual private networks (VPNs), which are smaller, propriety internets. Taken together, the Internet and VPNs are evolving into a global electronic market place of goods and services and ideas and information.

Providers and advertisers of products, information, and services find the Internet to be an attractive new communication medium. Consumers and users are also increasing their use of the Internet. Mechanisms such as directories and search engines index and organize the information on the web. The search engines then allow users to search the Internet for a listing of web sites and pages based on a specified topic, product, service or word or group of words.

Search services offer advertisers extensive reach into the Internet audience and provide opportunities to target consumers based on their use of keywords and search topics. The search engines and web site directories of the prior art, although now used extensively by advertisers, still provide no means for the brand managers and providers to stay in touch with the users and consumers.

Pull. Today's consumers obtain information on products and services through a variety of media. Traditional means include newspaper advertising, magazine ads, and other print media. Free product samples entice the user to try and later buy. CDs are used to describe a product using visual and audio.

Despite the multitude of entertaining and informative advertising methods targeted to and used by today's consumers, there is still no easy way for a consumer to communicate or stay in touch with the provider or brand manager.

The usefulness of the present invention is to provide bi-directional communication between the providers and users. The invention can be used in a variety of contexts, from advertiser-consumer, information provider-reader, musician-fan, manufacturer-buyer.

### BACKGROUND OF THE INVENTION AND ADVERTISING MODELS ON THE INTERNET

Search services are the most frequently used tool on the Internet after e-mail. Search services have offered advertisers significant penetration into the Internet audience while providing targeting opportunities through keyword and topical search requests. However, the information derived from search requests and any subsequent purchases fail to establish a full and equal relationship between the provider and the consumer. Thus, there is a need in the industry to extend the relationship beyond the initial search and subsequent purchase so that the user may tailor the content and choose the permitted senders.

One problem with existing advertising model is their indiscriminant broadcasts of unsolicited communications. Once a user buys on-line, they are then potentially subjected to dozens or hundreds of following ads. A related problem is that there is no easy way for the user to signal their willingness to receive such communications within their own specified limits or to influence their content. Hence, there is a need in the industry for a means for communicating in both directions between providers and users the preferences and information that each has.

The web advertising model extends traditional media broadcast models. The broadcaster, i.e. a web site, provides content—usually for free—and services such as email, chat, and blogs—mixed with advertising messages in the form of banner ads. The banner ads may be the major or sole source of revenue for the broadcaster. The broadcaster may be a content creator or a distributor of content created elsewhere. The advertising model works best when the volume of viewer traffic is large or highly specialized. However, current paradigms for Internet advertising fail to utilize the unique attributes of the Internet or provide a means to sustain the relationship between providers and users of the Internet.

Data about consumers and their consumption habits are valuable, especially when that information is carefully analyzed and used to target marketing campaigns. Independently collected data about producers and their products are useful to consumers when considering a purchase. Some firms function as infomediaries (information intermediaries) by assisting buyers and/or sellers understand a given market. However, current technology fails to provide sufficient information in a timely manner such that the provider may tailor content and the target based on results and user response, much less in substantial real-time.

Traditional models of advertising and search engine technology have failed to effectively deliver relevant information to interested users. Ideally, providers should be able to control their placements so as to maximize effectiveness while minimizing annoyance. Similarly, consumers should be able to control the flow of content and advertisements sent to them. Thus, there is a need in the industry for a bi-directional communications platform between providers, mainly advertisers, and users, mainly consumers.

With proper tools, advertisers should be able to customize their content for a select group of consumers and then communicate their targeted advertisements solely to those users who are most interested in receiving them. Ideally, the provider should be able to adjust the content of their campaigns based on results and user input, while consumers should be able to adjust the amount and type of communications targeted and sent to them. Thus, there is a need in the industry for a systems and means for enabling interactive or intelligent communications between providers and consumers.

It is an object of the present invention to provide a system and method for providers to make content available to users through targeted communications and for users to make their data available through tailored solicitations.

A further object of the invention is to enable the users to solicit targeted communications and to influence the number and type of targeted communications they receive through defining their user preferences while allowing providers to tailor their content based on user input.

It is an object of the invention to provide a search engine based information retrieval system and method for collecting and storing the information, in one mode for providers to create tailored and targeted communications, and in a second mode for users to select, influence, and receive such communications.

It is another object of the invention to provide a cost-effective method of advertising where the provider may tailor and communicate its content to an audience that defines itself in size from mass markets to individually targeted consumers.

A further object of the invention is to provide a system and method for enabling providers to examine the effects of their advertising campaigns and to make substantially real-time changes to their content and targets.

It is another object of the invention to enable users to increase or decrease the number of targeted communications received while also allowing them to influence their content.

It is also an object of the invention to allow a provider and user to establish a relationship beyond a single sale-purchase transaction.

Many advantages can be derived from the above. On-line and off-line advertisements can be targeted based upon provider analysis of the system's databases, user input, preferences, and usage history, as well as user responses.

It is still another object of the invention to create a fair system for creating and sending targeted communications, including advertising, product warranties, and warnings.

One object of the invention is to consolidate access to all providers into a single tool bar on the user's computing or communication device.

### BRIEF SUMMARY OF THE INVENTION

The present invention seeks to solve the aforementioned problems by providing a system and method for enabling communication between providers and users so that the user may opt-in and specify the type, number, content, and sources of communications while the providers may tailor their content in substantially real-time by analyzing the user input and data. In addition, the present invention allows users to influence the number, content, and type of communications received.

In a preferred embodiment of the present invention, an advertiser selects the targeted consumers based on both the static user information and the dynamic user information in the database and then tailors the advertisement to maximize the likelihood of success, and in turn, the results of the campaign and further responses from users are fed back into the process to produce iteratively highly tuned ad campaigns.

To participate in this process, a provider initially creates content tied to a product or service. The provider supplies some means of communication for the end user, e.g. a CD or click-on area on a web page. The provider enables the user to join or opt-out or do something in between, so that the users receive all of the provider content, some of the content or none at all. However, the user always has the ability to change their receiving preferences.

As part of the invention, users must register before receiving any targeted communications from providers. Once the user opts-in, the system retrieves and stores user data, such as age, date of birth, past consumer activity, preferences or anything else that will uniquely identify the user and provide information that can be used to customize targeted communications. The basic user data that is input during the opt-in process is stored in a static user database, while information on purchases and system usage is stored in a dynamic user database.

The invention allows providers to collect user data from multiple user sessions and opt-ins for further analysis and then intelligently analyze. The user and provider benefit from the amalgamating ability of the system to use user input and data from one provider or input session with one or more subsequent opt-ins. Thus the system creates mutual benefits from returns to scale for both providers and users.

An important benefit from the amalgamation is that the provider can use data from one session with data from another session of the same user. For example, during an initial opt-in, the user may provide name, address, and age. During a second user session, the same user may provide weight, favorite sports team, and information on hobbies. The invention provides a means to connect the two sessions with the permission of the user. The user benefits because he does not have to fill out the same basic data each time he want to participate in a providers promotion, while the providers benefit by having access to much more data.

The system provides for real-time communications and immediate analysis software. Both the provider and the user can react substantially in real-time to the results of advertising campaigns. The invention makes communications easy for the user by consolidating all access methods into a single taskbar on the user's communication or computing device.

According to a first embodiment, the invention provides a system and method for enabling advertisers to establish communications with users through a promotional item. The user follows directions in the promotional item to log in to the advertisers web site and provide static user data such as age, income level, living location, and product preferences. At this time the user also specifies whether to receive additional communications from the current or other providers. Subsequently, the user may provide dynamic user data by participating in another session to provide feedback to a provider campaign, which information the provider uses to tailor its content and target audience. As the user opts-in to more providers, all of the access-points to various providers are consolidated into a single area, preferably an expandable taskbar on the user's computer or communication device, thus easing communications for the user. As the user opts-in to more providers, the static and dynamic user data may be amalgamated by one or more providers, who pay for access to all of the user data. The privacy of the user is guaranteed in that information is solicited generally but input is specifically accepted only with the initiative of the individual user. Each user may specify the data that he inputs while also specifying the range of privacy from total anonymity to full disclosure. The invention provides a database system that is separate from any provider or user to store static and dynamic user data, information from the providers, and results of advertising campaigns.

One embodiment of the invention is to provide a system and method for having a database store accounts for providers and individual users. Each account includes contact and billing information for the promoters and usage history and product and provider information for the users. Each provider account includes at least one product or service, while each user account contains static and dynamic user data and usage history. Each account may include payment and detailed usage history. The provider logs into their accounts in order to retrieve information. The users log into their accounts in order to provide static and dynamic user data and usage history.

The present invention addresses the existing problems and bottlenecks in traditional media and Internet advertising and marketing by providing a method and system for bi-directional communication between providers of information and users, and between advertisers and consumers. The invention allows the user to create an information viewing cart and enables the provider to create a user preference-usage cart.

The invention provides added value to any marketing or advertising campaign by allowing the advertiser or brand manager to first gather information on target users, receive responses from them, and then customize and target further advertisements in real-time.

The invention provides added-value to the consumer by enabling the consumer to customize the amount, type, and source of advertisements received and read. Instead of relying on a deluge of unsolicited communications, the user instead logs into and chooses those advertisement or targeted marketing communications that he will receive. On the other hand, the user provides any information that could be useful to the advertiser. A method for combining user sessions and data across multiple platforms and advertisements and campaigns is provided, so as to generate increasing returns to scale.

The invention allows several ways of making or generating revenue. The user databases may be licensed entirely or partially, depending on the permission levels granted by the individual users. Pay-for-performance payments may be made by providers based on their use of the invention to increase return on investment.

### BRIEF DESCRIPTION OF THE DRAWINGS

These and other features and advantages of the invention will now be described with reference to the drawings of certain preferred embodiments. These illustrations are intended to describe and not to limit the invention.

FIG. 1 is a high-level illustration of the world of advertising illustrating television, billboards, print media, and an individual target.

FIG. 2 illustrates the ability of itt rom™ component to distribute information and services non-obtrusively through the Internet while also collecting information from users.

FIG. 3 illustrates how the itt rom™ is integrated with marketing and advertising campaigns.

FIG. 4 illustrates the communications features, including chat, video, audio, cell phones, and web casting, to list a few.

FIG. 5 illustrates the benefits to consumers and providers of itt technology.

FIG. 6 compares the advantages of itt rom™ with the average web site.

FIG. 7 illustrates the benefits of the itt technology across brands of multiple providers.

FIG. 8 illustrates the benefits of itt technology.

FIG. 9 introduces itt Mobile™.

FIG. 10 illustrates the. incorporation of itt Mobile™ in various technologies.

FIG. 11 illustrates the Gateway Services™ component.

FIG. 12 further illustrates how a consumer uses a product code.

FIG. 13 provides an overview of itt Com™ and the invention's Internet web portal.

FIG. 14 illustrates an overview of itt Com™.

### DETAILED DESCRIPTION OF THE INVENTION AND PREFERRED EMBODIMENTS

### 1. Overview of System Components and Operation.

The invention is a platform for enabling an intelligent bidirectional communications between providers of information and users of information. The invention utilizes communications links to enable and enhance communications between the providers and the users; data warehouses to store information on providers and users, as well as the usage history or each; enrollment lists of providers and users to keep track of who is using the platform, including responses by both providers and users to each other's communications.

The invention provides access points to providers and users through consolidated icon trays. A bi-directional communicator allows the use of all forms of communication, including the Internet, e-mail, web casting, blogging, and mobile communications devices such as cell-phones and personal digital assistants.

### 2. Consumer Enrollment Function.

The provider Web site includes automated enrollment software for allowing users to enroll. Users may enroll with an itt rom™ promotion or on their own initiative. The user registration process may include the following: (1) performance of the instructions contained in the itt rom™ promotion, e.g. a prize code or login password; (2) input of basic user data such as name, address, zip code etc.; (3) the automated generation of a user id; (4) user selection of preferences for receiving content and marketing communications; (5) generation of one or more user accounts to track user data, transaction and usage history, and responses.

### 3. Provider Enrollment Function.

The provider Web site includes enrollment software for allowing providers to enroll. Providers may register their use of an itt rom™ promotion or campaign. The provider registration process may include the following: (1) inputting of the instructions contained in the itt rom™ promotion, e.g. a prize code or login password; (2) inputting of provider responses to user registration; (3) analysis of basic user data such as name, address, zip code etc.; (3) analysis of detailed user data such as age, weight, etc.; (4) amalgamation of basic and detailed user data; (5) analysis and responses to user selection of preferences for receiving content and marketing communications; (6) analysis and responses to user data and preferences; (7) generation of one or more provider and campaign accounts to track user data, promotional data, analysis, user responses, sales, etc.

### 4. Targeted Marketing Communications Generator.

Methods and systems for generating and paying for targeted marketing communications are disclosed. The unique abilities of the invention to add value to providers through access to user data mean that the user of the invention may charge commissions. Methods and systems for generating reports and charging commissions are disclosed.

### 5. Invention Disclosure and Description of Figures.

The following descriptions are presented to enable any person skilled in the art to make and use the invention, perhaps with some experimentation. For purposes of explanation, specific nomenclature is used to provide a thorough understanding of the present invention. However, specific examples are used only to describe and not to limit the scope of the invention.

Various modifications and adaptations of the invention will be readily apparent to those skilled in the art, and the general principles defined here may be applied in other embodiments and applications without departing from the scope, nature, and spirit of the invention. The present invention is to be accorded the widest scope consistent with the principles and features described here and not limited by the embodiments or examples presented.

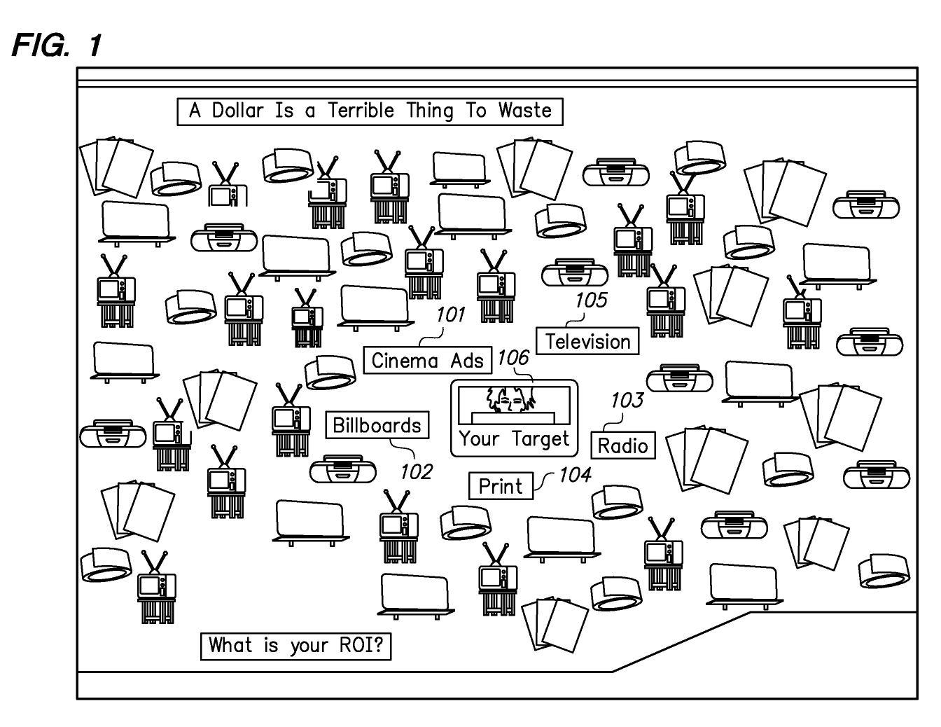

Referring now to the drawings, FIG. 1 is an example of the world of advertising in which advertising dollars are spent, e.g. on cinema ads 101, billboards 102, radio 103, print media 104, and television 105. The aim of all of these communications means is to reach the individual consumer or user target 106.

The conventional advertisements are short-lived and one-way, in that consumers and buyers have no easy means for communicating with the provider of the message other than transacting a purchase. Providers have no ability to tailor ads and send them to targeted groups or individuals intelligently. Neither side has any means to establish a mutually beneficial relationship and build it continuously.

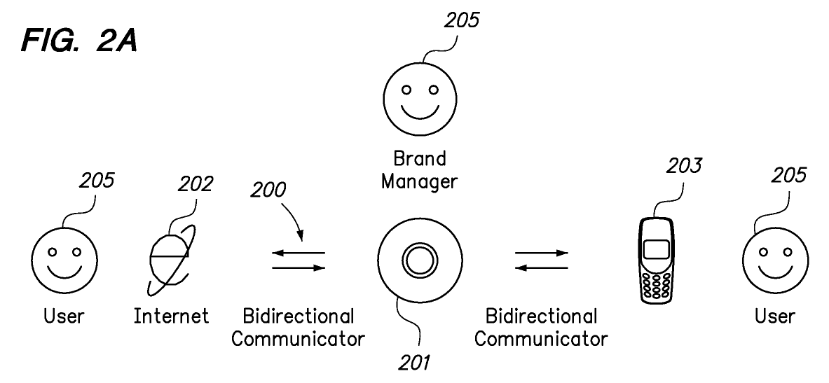

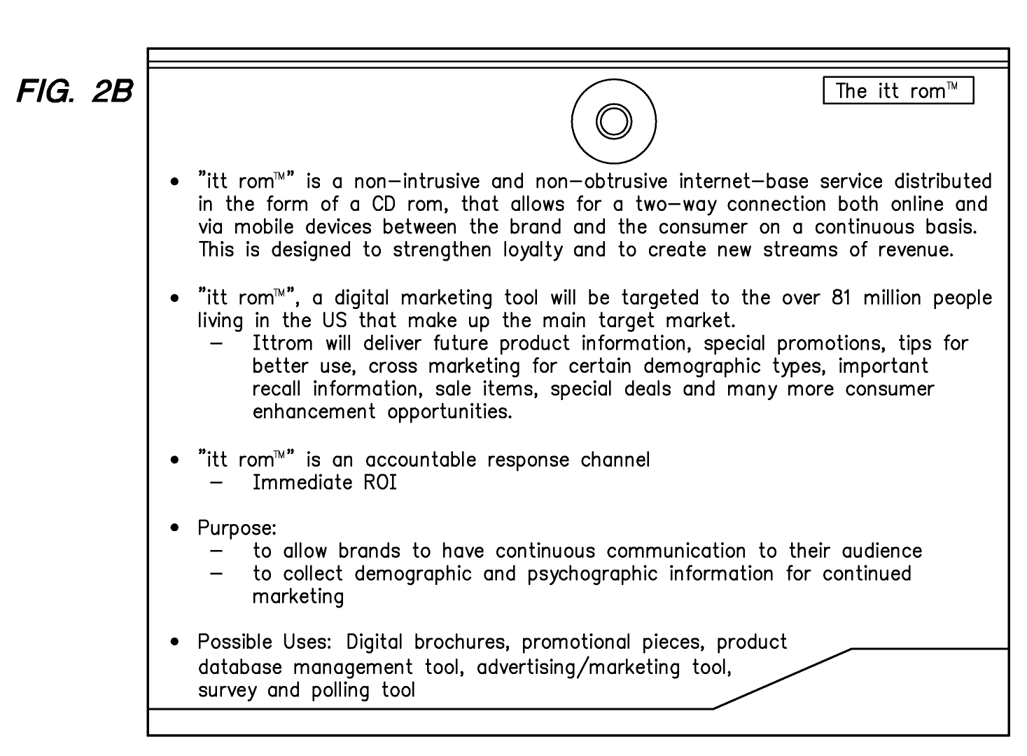

FIG. 2A illustrates the invention's use of a CD 201 as a means for a provider to initiate communication with consumers, users 205, and brand managers 205. Using a CD 201, the itt rom™ is a device and method for allowing bi-directional communication 200 between users 205 and providers (brand managers) 205 via the Internet 202 and mobile communication devices such as cell phones 203. The CD provides the means for the consumers initiating a relationship with the provider or advertiser. The supporting software applications of the invention enable the provider and user to maintain a long-term, continuous relationship.

FIG. 2B discusses further how itt-rom™ works. The itt-rom™ is non-intrusive in that the user controls the communications from the provider. The itt-rom also provides an accountable response channel because each user is assigned a unique identification-access key 306.

In this example, the CD is distributed with an event, product or service. Once the user has the CD, he may login into the website or the provider and opt-in and provide user data. The CD is only one of many ways of initiating contact between providers and users, and the concepts describe in the present invention may be applied to other means for the users 205 to initiate the relationship and bi-directional communication 200 with the brand managers 205.

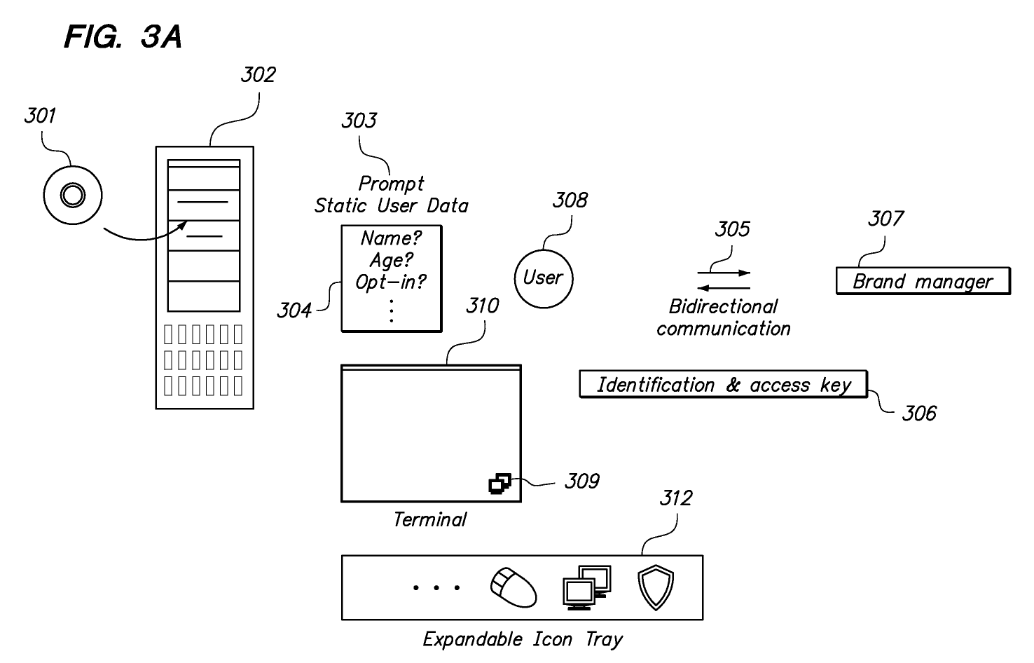

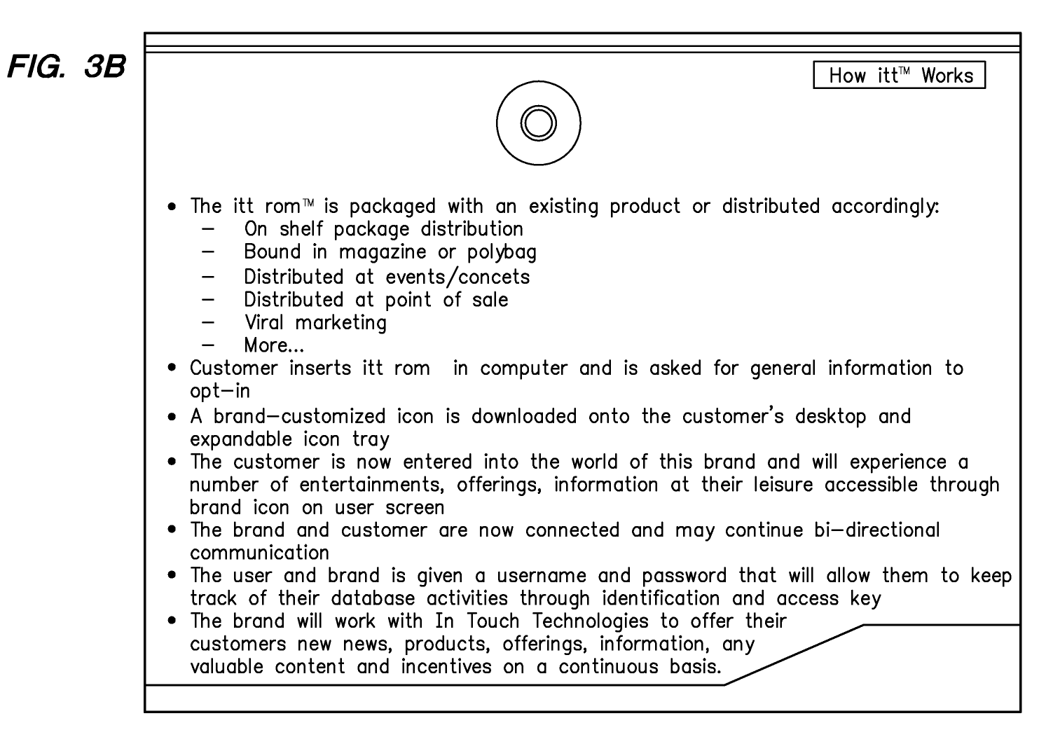

FIG. 3A illustrates how itt rom™ works. The itt rom™ technology is packaged with an existing product or distribution means. The CD or other trigger is packaged with an existing product or distribution media, e.g. on shelf packaging, magazines or polybags, event distributions, point of sale distributions, and viral marketing. As a first step, the user 308 inserts the CD itt rom™ 301, 302 and is prompted for basic user information 303, i.e. static user data 304. Once the user opts-in 303, the brand's icon 309 is downloaded onto the customer's desktop terminal or communication device 310. Thereafter the user 308 may access the brand manager 307 through the expandable provider icon tray 312 and use the bidirectional communicator 305.

FIG. 3B presents the advantages of itt rom and the invention. One of the principle purposes of the itt rom™ is to enable the user to opt-in 303 and provide to providers basic user data 303 at first and later on more detailed information on preferences and habits. The invention consolidates the user's access to all of the providers through a common platform and expandable icon tray 312. Multiple brands from all opt-ins find there way into a single point of access on a toolbar on the user's screen interface 309, 310, 312.

Once the provider and user have established their initial connection through the bi-directional communicator 305, each is provided with an account, password, and unique access-identification key 306. By using this key, the user may consolidate their user preferences across multiple brands, while the multiple providers may amalgamate the individual input of each user to create a more complete user profile.

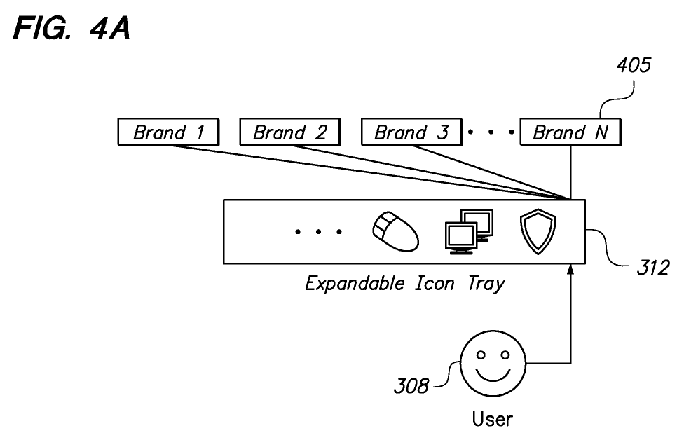

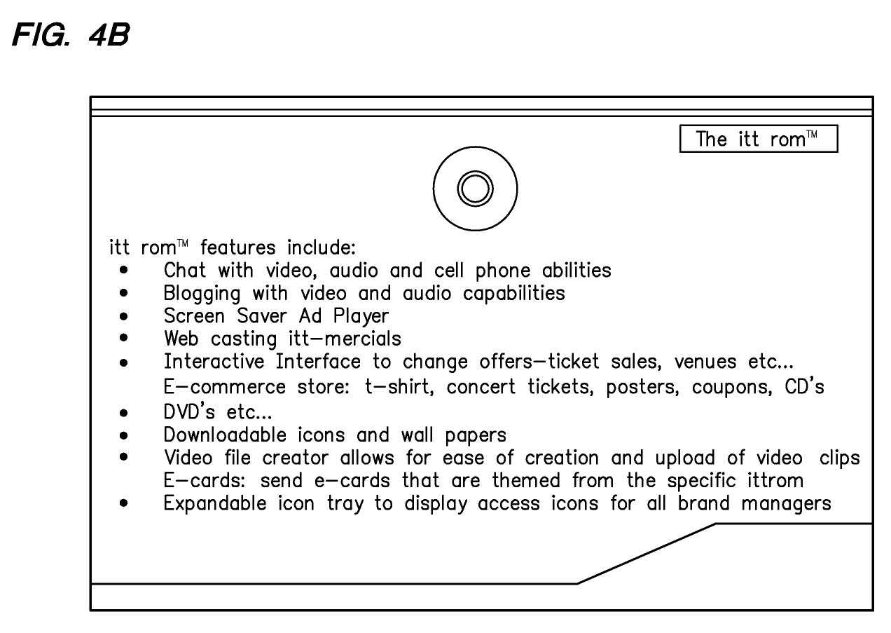

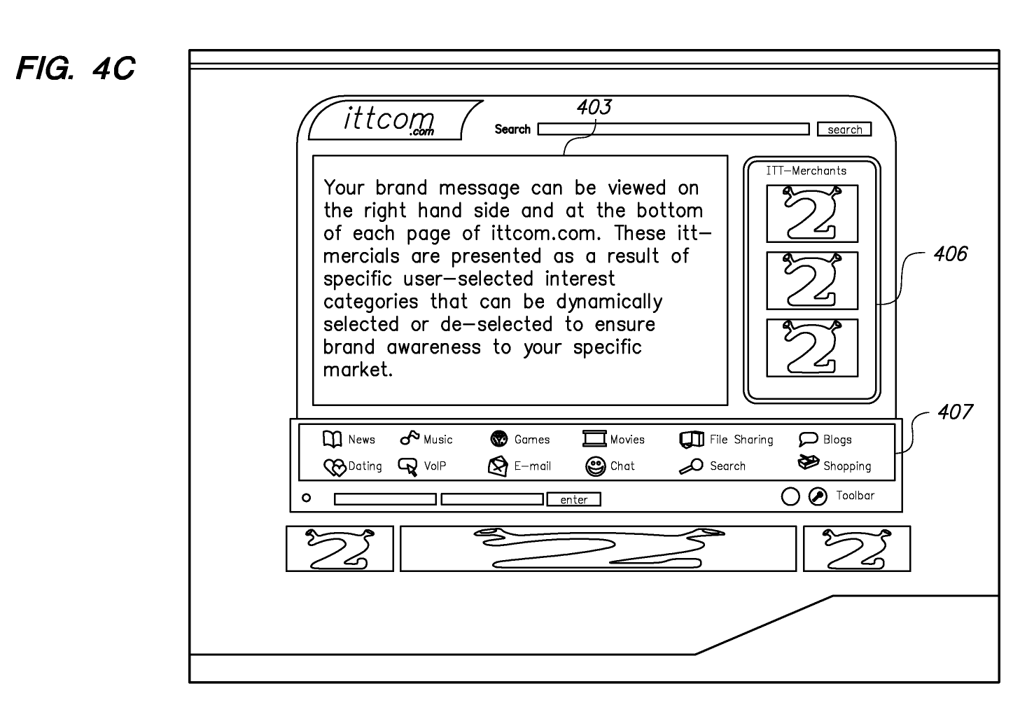

FIGS. 4A and 4B illustrate the advantages to the user and provider of using the invention. By using the expandable icon tray 312, the user 308 may access and receive specialized or tailored content from the providers and brand manager 405. receive coupons or special promotions, and access information with limited distribution 407, as shown in FIG. 4B. Providers 405 will be able to have direct communication with targeted consumers, opportunities for sending tailored information 403 to self-selected, targeted groups, and measure return on investment or return on advertising based on user metrics. While in this example the CD is the enabling device, the invention may utilize other devices to begin this process.

FIG. 4B illustrates other features of itt rom™. Chat, video, cell phones, blogging, screen savers, Web casting, interactive sales, e-commerce, e-cards, and other communication forms may be integrated with itt rom™ 407. For example, coupons may be distributed with on-line ticket sales and contain instructions for accessing the invention through a special web page 403, 406.

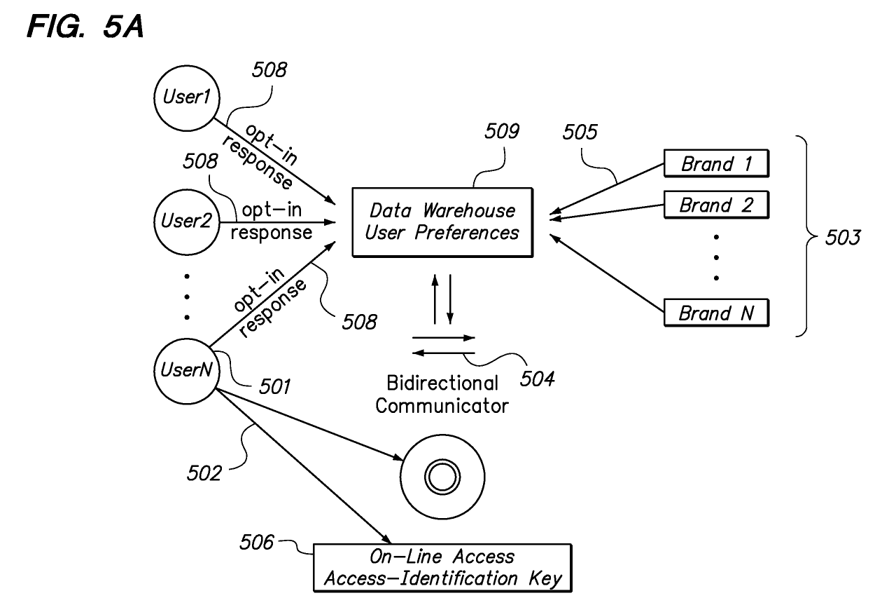

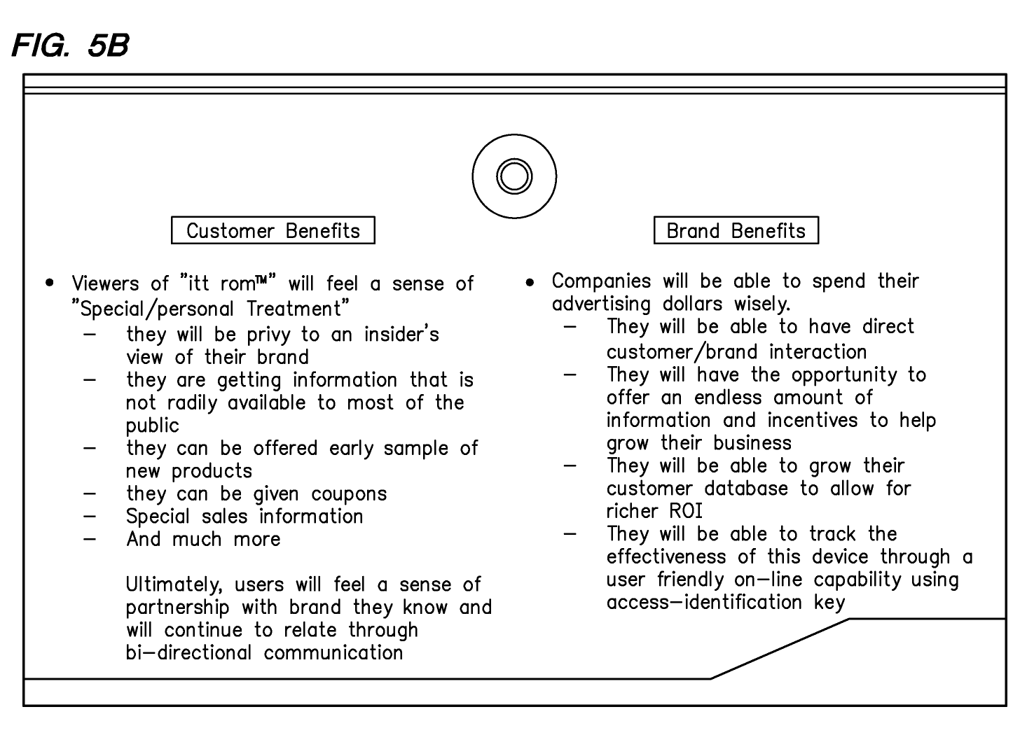

FIG. 5A illustrates how the users 508 receive special benefits from the brand providers 503, after opt-in 508. Brand managers or providers 503 will be able to spend advertising dollars wisely, based on the users' opt-ins 508 and preferences stored in the data warehouses 509. As can be seen in the illustration, providers may amalgamate user data from one or more opt-ins, user sessions, and user preferences to tailor special content for each user individually, and users may consolidate their preferences and opt-ins options over multiple providers, all through the bidirectional communicator 504 and data warehouses 509.

FIG. 5B compares and discusses the advantages of the invention for customers and brands.

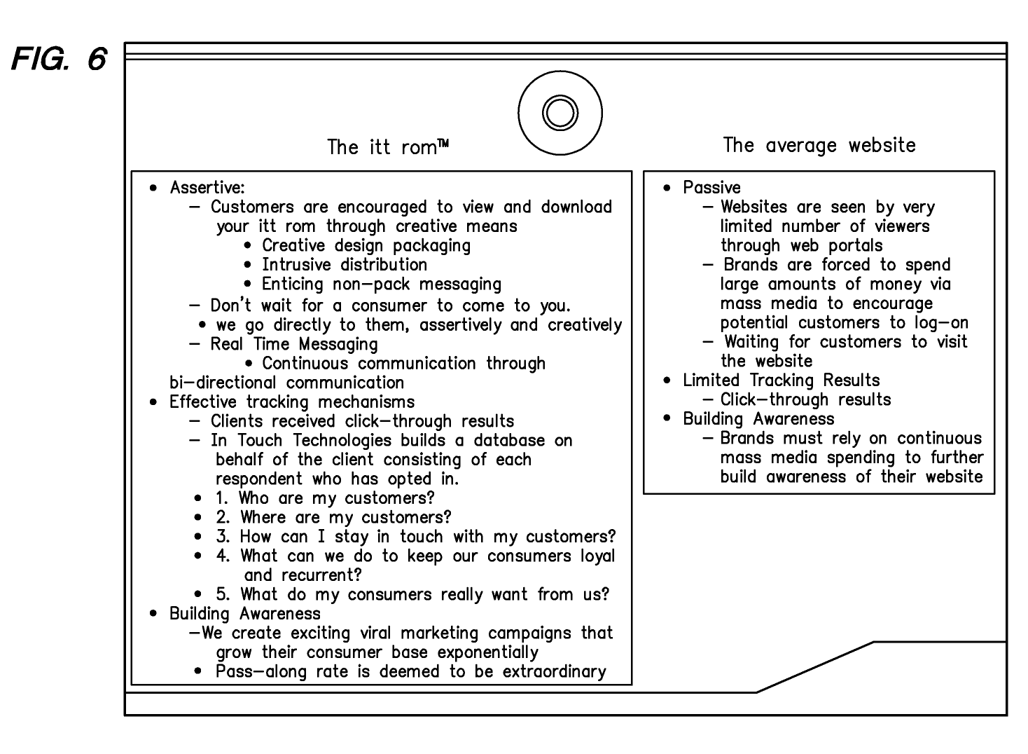

FIG. 6 illustrates the advantages of the itt rom™, such as building brand awareness through viral marketing over the typical passive website. Itt rom™ enables user-initiated real-time communication through the bi-directional communicator, whereas the average website waits for consumers to visit. Itt rom™ provides effective means for tracking consumers through user-initiated opt-ins and user sessions in which users provide user data, whereas the typical website's tracking is limited to analyzing the results of anonymous click-throughs.

Whereas the average website still depends on mass media ad campaigns to generate interest and build brand awareness, itt rom™ encourages viral marketing campaigns that grow organically. In this illustration of the invention, while the CD may be tied into other items and activity, e.g. chat, cell phones, blogs, screen savers, web casting, interactive sales, specific products such as t-shirts, concert tickets, and e-cards, other devices may serve as the initial point of contact between the providers and the users.

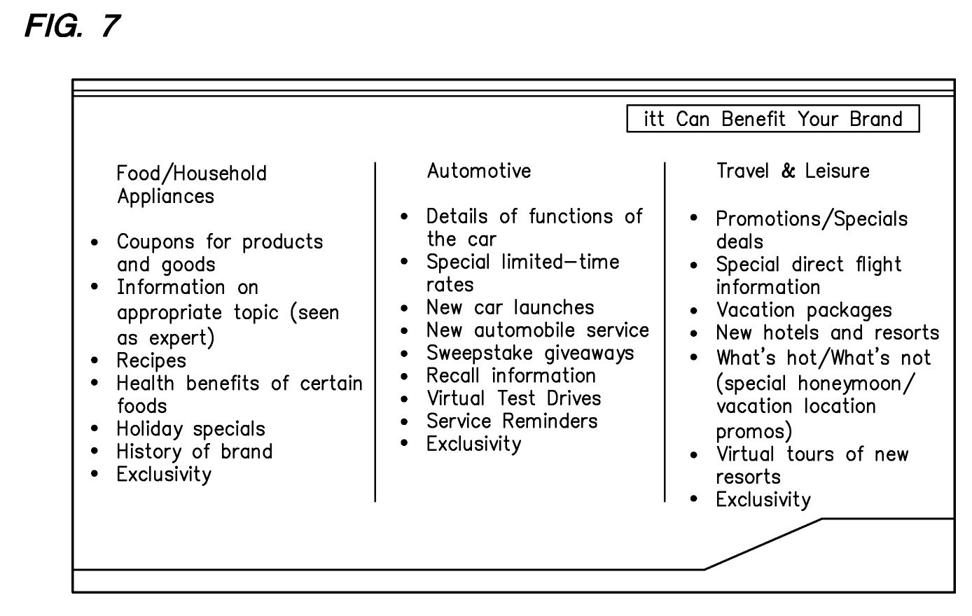

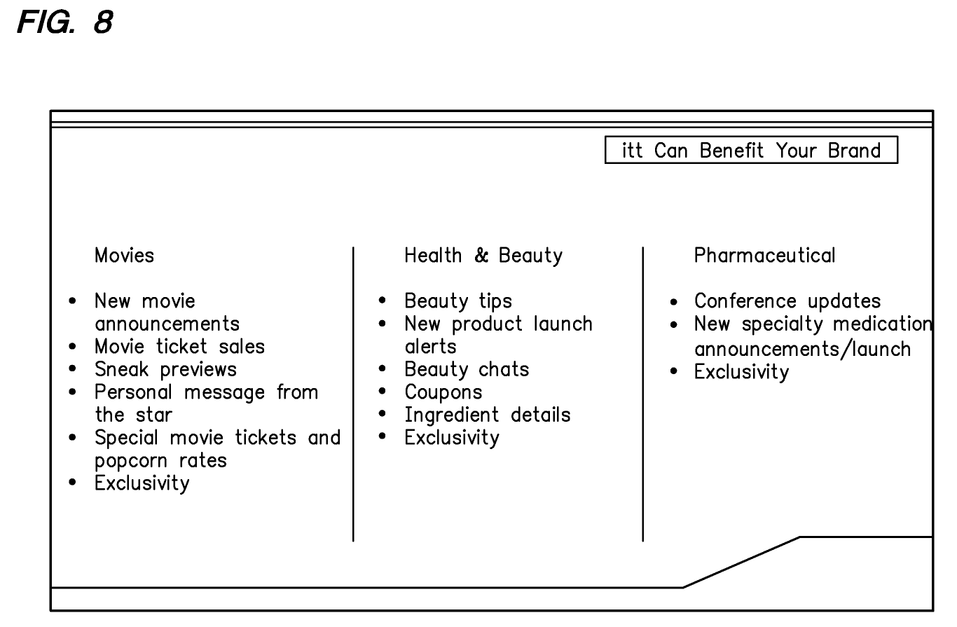

FIGS. 7 and 8 illustrate how the invention can build brand value through targeted marketing communications and demonstrates the uses of itt technology.

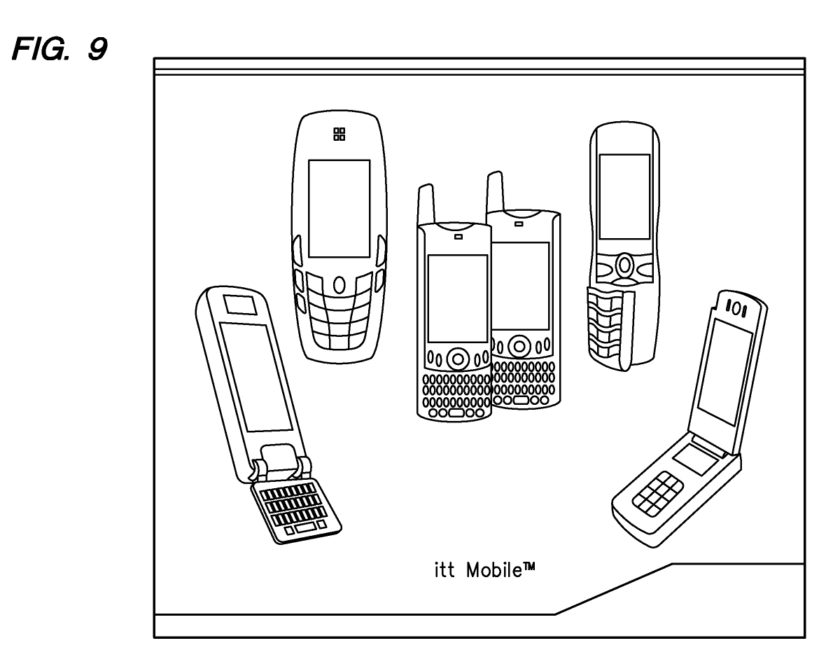

FIG. 9 illustrates itt Mobile™ and the invention's use of mobile communications technology.

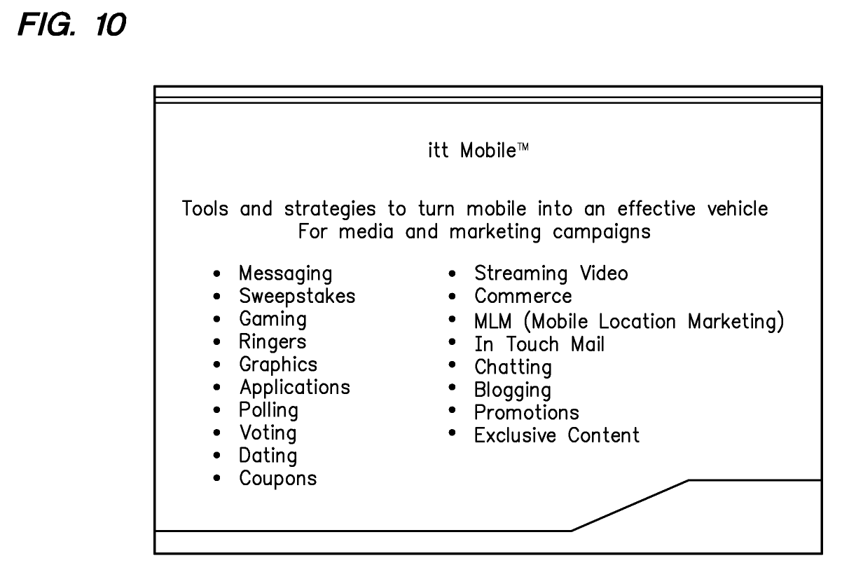

FIG. 10 illustrates itt Mobile™ and how the world of mobile communication devices, including the cell phone, may be adapted to the invention through itt Mobile™. While the user may communicate through a personal computer or any communication device, the mobile phone takes best advantage of the invention's ability to respond to user input.

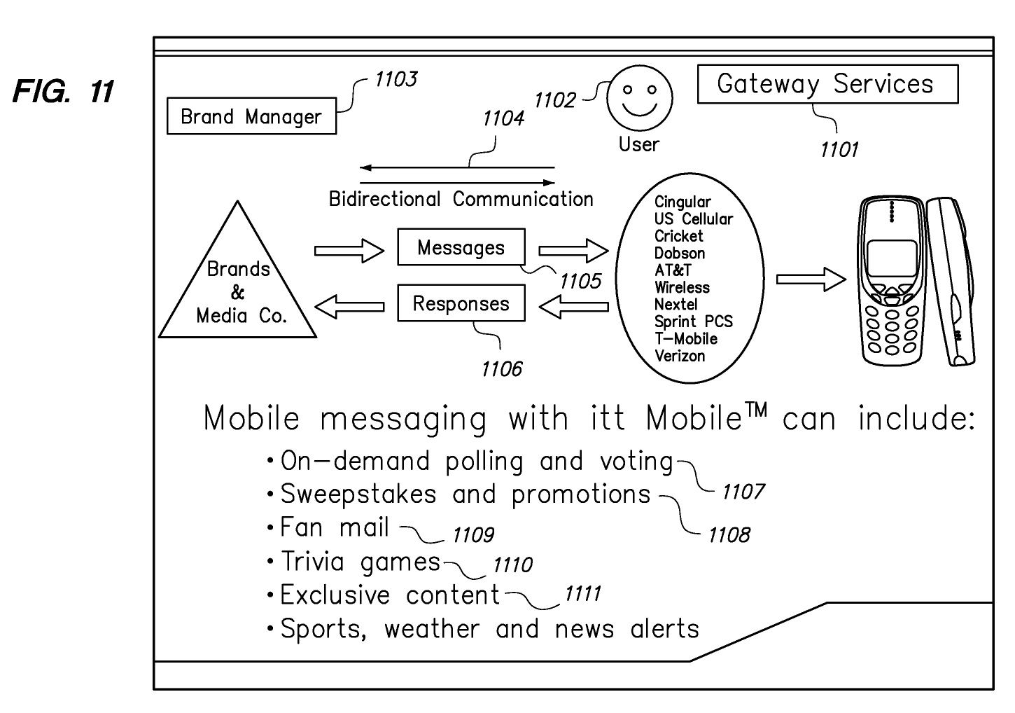

FIG. 11 illustrates how Gateway Services™ 1101 and communications between providers and brand managers 1103 and consumers and users 1102 may occur through mobile communication devices such as a cell phone that are integrated into the bidirectional communicator 1104. Through the bi-directional communicator and intelligent software for analysis, providers may keep marketing and advertising campaigns up-to-date with the most current communications technology with messages 1105 and responses 1106. In addition, consumers may opt-in and provide user data in real-time. In one implementation of mobile messaging with itt Mobile™ through Gateway Services, various providers such as pollsters and voting machines 1107, sweepstakes and promotions 1108, fan mail 1109, games 1110, news, sports, and weather channels, as well as exclusive 1111 content disseminators make content available to consumers while also enabling the consumer to react to the tailored content received through responses 1106.

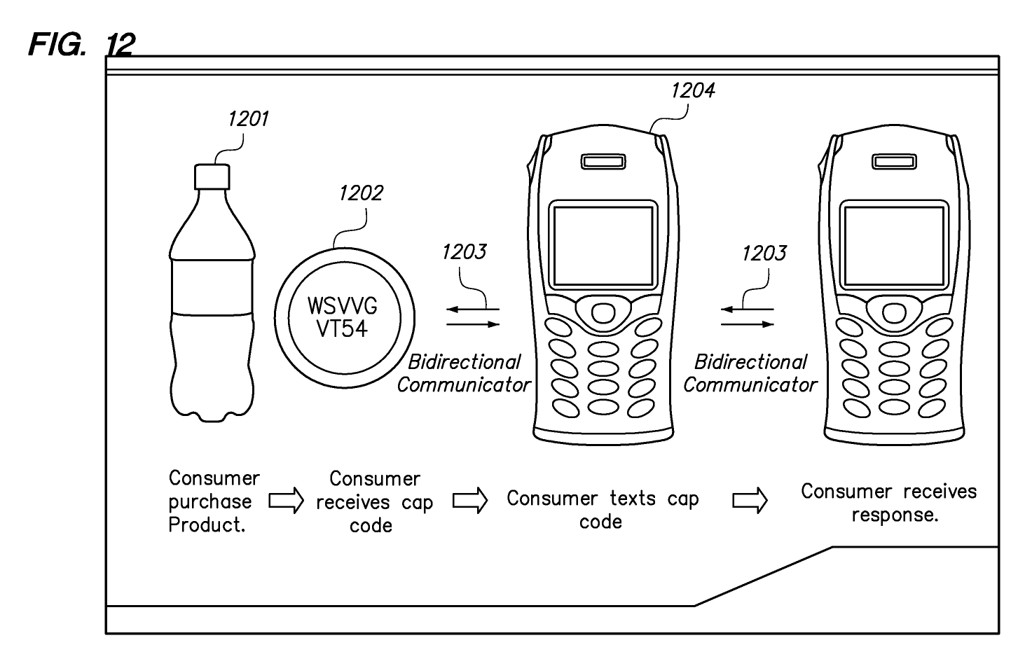

FIG. 12 illustrates how a provider message can be used by a user to communicate with the provider and receive a response through one aspect of the invention, i.e. the bi-directional communicator. In one implementation, the consumer purchases a product 1201 that contains a code 1202, e.g. a soft drink with a cap code. The consumer then uses the bi-directional communicator 1203, e.g. through a cell-phone 1204, to enter the code 1202, thus initiating a user session to opt-in or provide user data.

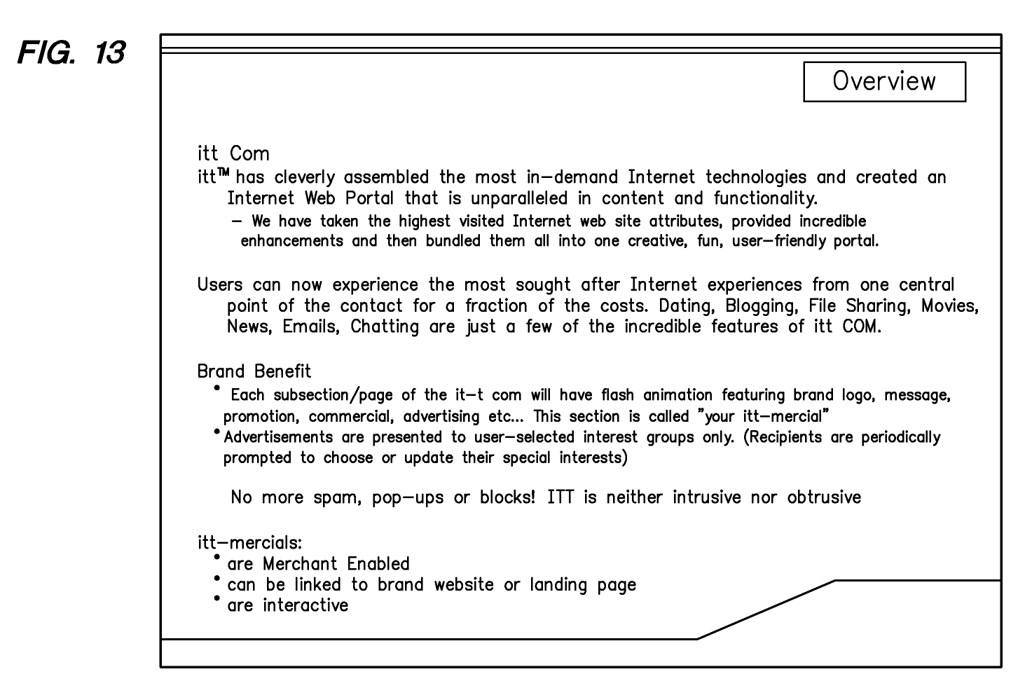

FIG. 13 shows itt Com™ benefiting brands, including bundling Internet communication technologies into a single service: the user may access dating, blogging, file sharing, news feeds, e-mail, and chat through a single interface of Itt COM. The provider creates an itt-mercial targeted to users who have previously opted-in or indicated a preference or consent to receiving targeted marketing communications. Periodically users are prompted to renew their opt-in or modify their preferences. Itt-mercials™ allow the user and provider to communicate interactively. Since the generation and receipt of Itt-mercials depends on user initiated contacts, there is no more spam, pop-up ads or blocks.

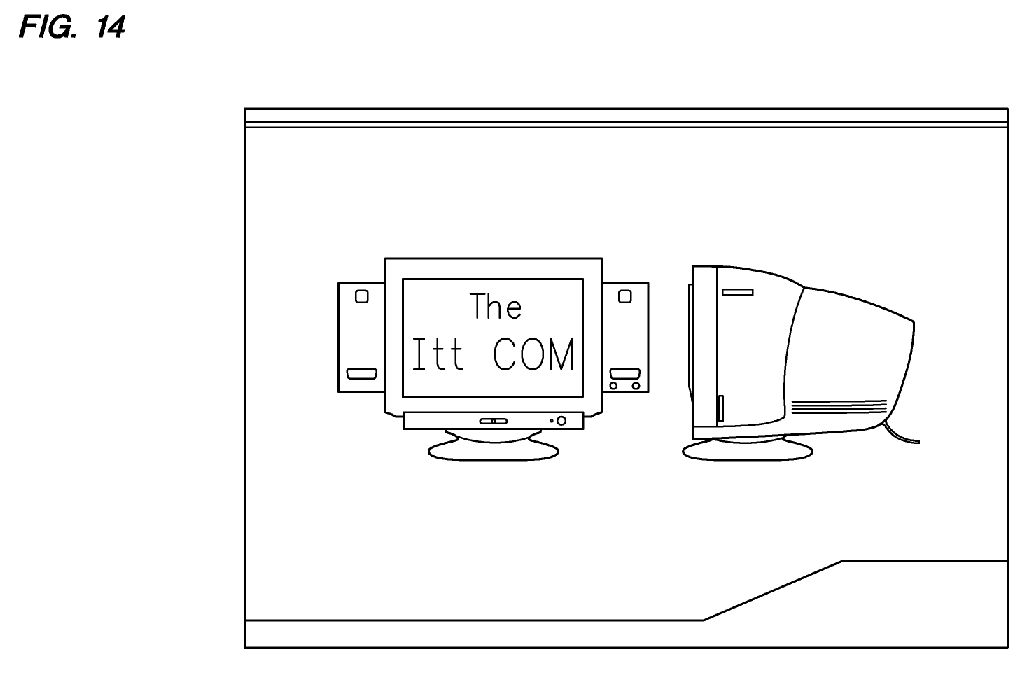

FIG. 14 illustrates some of the information available to providers through itt Com™: the user selects preferred brands or products, the provider analyzes the user preferences and then creates tailored content to send to targeted users. The provider is able to response to user input in substantially real-time, while the user is able to change his preferences at any time.

What is claimed is:

1. A platform for enabling an intelligent bidirectional communicator between a plurality of providers of information and a plurality of users of information, comprising:
communications links between the providers and the users;
communications between the providers and the users;
data warehouses for provider information and user information;
enrollment lists of providers and users;
responses by the providers and the users; and
access points to the providers and to the users.

2. A platform of claim 1, further comprising computer systems for managing the communications links, the communications, the data warehouses, the enrollment lists, the responses, and the access points, and a plurality of user computers and a plurality of provider computers.

3. A platform of claim 2, wherein:
the communications links include communications means between the plurality of providers and the plurality of users, said communications means having a computer system and screen, said computer system having communications port;
the data warehouses include a provider data warehouse, consisting of a plurality of provider databases, said provider databases retrieving and storing provider information data, provider usage data, provider content data, and provider instruction data, and a user data warehouse, consisting of a plurality of user databases, said user databases retrieving and storing static user data, dynamic user data, user preference data, user usage data, and user response data;
the enrollment lists include a provider enrollment process which enrolls the providers to form a provider enrollment list, and a user enrollment process which enrolls the users to form a user enrollment list;
the responses include users responses received through a user response process and stored in the user data warehouse, and provider responses received through a provider response process and stored in the provider data warehouse;
the access points provide access to the providers and provider data warehouse for the users, and access to the users and user data warehouse for the providers; and
the communications include provider communications sent to users and user communications sent to providers, said provider communications and said user communications containing information from the provider data warehouse and the user data warehouse.

4. A platform of claim 3, further comprising preferences, said preferences including user preferences specified by the users through a user specifying process specifying type, frequency, and source by provider of provider communications desired to be received by the users, and provider preferences specified by providers through provider specifying process specifying the user profile of target group of users desired by provider.

5. A platform of claim 4, further comprising a user cart, said user cart including a list of users meeting the provider preferences for users and containing provider data from provider data warehouse, and means for sending the user cart to a targeted group of users.

6. A platform of claim 5, further comprising a provider cart, said provider cart including a list of providers meeting the user preferences and containing information from the user data warehouse and the provider data warehouse, and means for sending the provider cart to a targeted group of users.

7. A platform of claim 6, further comprising generating and sending targeted marketing communications, wherein said targeted marketing communications contain information based on said user preferences and user data warehouse and provider data warehouse, said targeted marketing communications being sent to a target group of users through said bi-directional communicator.

8. A platform of claim 7 for receiving and sending user responses to said targeted marketing communications, wherein said user responses contain information that is stored in the user data warehouse and the provider data warehouse.

9. A platform of claim 8, for generating user responses to said targeted marketing communications, said user responses being sent through said bi-directional communicator.

10. A platform of claim 9, for modifying said targeted marketing communications based on said user responses to create modified marketing communication, said modified marketing communication being sent to a target group of users.

11. The platform of claim 3, wherein said bi-directional communicator uses a cell-phone or mobile communications device.

12. The platform of claim 11, wherein said user response is a bar code read by a cell-phone with camera and communicated to at least one of said plurality of providers through said bi-directional communicator.

13. The platform of claim 3, wherein said user enrollment process is through a downloadable software application.

14. The platform of claim 13, wherein said enrollment process generates a identification-access key that is unique to each user and stored in the user data warehouse and the provider data warehouse.

15. The platform of claim 3, wherein said user enrollment process is through a cell-phone or mobile communications device.

16. The platform of claim 3, wherein said user response is through a downloadable software application.

17. The platform of claim 3, wherein said user response process is through a cell-phone or mobile communications device.

18. The platform of claim 3, wherein said user response is a user opt-in through a downloadable software application, said opt-in specifying whether said user will receive communications from one or more of said providers.

19. The platform of claim 3, further comprising providing analytical software for analyzing said provider databases and said user databases to generate provider reports and user reports.

20. The platform of claim 19, further comprising generating user profiles based on analyzing information in said user databases and said provider databases using said analytical software.

21. The platform of claim 20, further comprising collecting user data from multiple entries in said user databases for the same said users for analysis by said analytical software using said identification-access keys.

22. The platform of claim 21, further comprising developing a group of targeted users based on said user profiles.

23. The platform of claim 22, further comprising generating custom content for marketing communications.

24. The platform of claim 23, further comprising sending said marketing communications to said group of targeted users.

25. The platform of claim 24, wherein said communications consists of marketing communications, comprising:
information based on said user databases;
information based on said provider databases; and
information based on said analytical software.

26. The platform of claim 25, wherein said marketing communications are managed by an ad server, comprising:
means for obtaining user information from said user databases;
means for obtaining provider information from said provider databases;
means for generating said marketing communications based on said user information and said provider information;
means for sending said marketing communications to said group of targeted users; and
means for receiving user responses to said marketing communications.

27. The system and method of claim 26, further compromising analyzing said user responses and modifying said marketing communications based upon said user responses.

28. The system and method of claim 27, further compromising creating and sending follow-on marketing communications based on said analyzing said user responses.

29. The platform of claim 3, wherein said bi-directional communications platform comprises:
at least one user communications link for said user devices;
at least one provider communications link for said provider devices;
software program for coordinating said user communications and said provider communications.

30. The platform of claim 30, wherein said bi-directional communicator platform utilizes a network.

31. The platform of claim 30, wherein said network is the Internet.

32. The platform of claim 31, where said bi-directional communicator platform utilizes mobile communications devices.

33. The platform of claim 32, wherein said mobile communications devices include cell-phones.

34. The platform of claim 3, further comprising substantially real-time communication through said bi-directional communicator platform.

35. The platform of claim 3, further comprising user access for said users to said providers through provider access hyperlinks, said provider access hyperlinks appearing on area on said user screens of said user computer.

36. The platform of claim 35, wherein said area contains at least one provider access hyperlinks.

37. The platform of claim 36, wherein said area contains up to all of provider access hyperlinks.

38. The system and method of claim 19, further comprising a method for charging commissions based on said provider reports.

39. The system and method of claim 38, further comprising paying of said commissions electronically.
